(19) United States
(12) Patent Application Publication
(10) Pub. No.: US 2009/0136067 A1
(43) Pub. Date: May 28, 2009

(54) Multi-function headphone system

(76) Inventor: Louis Sebastian Silvestri, New York, NY (US)

Correspondence Address: LOUIS S. SILVESTRI, ESQ., 408 WEST 39TH STREET, APT 1RE, NEW YORK, NY, 10018, US

(21) Appl. No.: 12/287,415

(22) Filed: Oct. 9, 2008

Related U.S. Application Data
(63) Continuation of application No. 10/941,212, filed on Sep. 15, 2004, now abandoned.
(60) Provisional application No. 60/503,715, filed on Sep. 19, 2003.

(51) Int. Cl. H04R 5/02

(52) U.S. Cl. 381/309

(57) ABSTRACT

A system and method for switching a monaural headphone or headset to a binaural headphone or headset and vice versa. Such a system and method is especially useful for utilizing audio, video, telephonic, and/or other functions in multifunction electronic devices utilizing both monaural and binaural audio.

This application is a continuation of Ser. No. 10/941,212, filed Sep. 15, 2004, which is a non-provisional application of provisional application Ser. No. 60/503,715, filed Sep. 19, 2003. Examiner Suhan Ni in Art Unit 2614 examined application Ser. No. 10/941,212.

### BACKGROUND OF THE INVENTION

With the advent of multi-function electronic devices (“MFEDs”), for example, devices combining email, audio, video, telephone, gaming, internet, recording, address book, and/or other functions, there comes a need for a multi-function headphone system and method in accordance with the present invention. The typical headphone or headset systems that are used with MFEDs are usually of the one ear only type (typically called monaural) or sometimes the two ear only type (typically called binaural), for use with each of the MFED's functions, whether or not each function typically or preferably is used with a one ear only or a two ear only headphone system. For example, the headphones that typically come enclosed with Blackberry™-type email capable devices and mobile phones are monaural, even though some such devices are capable of playing stereo music or other audio (e.g., via MP3) or video/audio features such as MPEGs or movies (e.g., DVDs). Attachments to emails often contain such stereo music and/or video/audio features. Downloaded or software driven forms are common as well. Additional types and formats of stereo audio will no doubt be available and utilized in MFEDs in the future.

The present invention embodies a one and a two ear system for use with such MFEDs, such that a user may utilize the system as a one ear system to perform a function, for example, engaging in a telephone call, and also be able to adjust the system to a two-ear system to engage in another, or the same, function, for example, listening to a song. Certain functions typically involve primarily using one ear or two. Telephone calls, for example, usually, and usually preferably, involve only one ear while listening to music or a movie usually, and usually preferably, involves both ears. The current invention combines the usefulness and utility of both a one ear only and a two ear only system to suit the multiple functions of MFEDs.

The major disadvantage of prior art headphone systems and methods is that neither a one ear only system or method nor a two ear only system or method is ideal for all or most MFED functions. For example, prior art headphone systems, used with MFEDs today, are designed, and typically used, for either one ear only or two ears only, not both. Thus prior art headphone systems used with MFEDs are not ideal because you cannot utilize particular MFED functions ideally unless two sets of headphones are provided and the user has both sets of headphones with them—and even in this case, it is inconvenient to carry both sets and switch between the two.

An MFED user cannot perform certain functions, such as listen to music or watch a movie, with two ears if the headphone provided and used is a one ear only system. Similarly, one cannot perform certain functions typically involving one ear if a two ear only system is provided and used as designed. It may also be inappropriate and/or dangerous to use a two ear only system in some circumstances as well. A one ear only system in accordance with the present invention that can switch between one ear and two, would remedy such a predicament.

While it may be the case that some prior art two ear only systems can be unartfully converted into a one ear system (such as by adjusting a prior art two ear only telescopic device to cover only one ear), it is usually difficult, inconvenient, and uncomfortable to do so. In any case, prior art two ear only systems are not designed for use as a one ear system, do not comprise intended one ear function features or intended switching or adjusting means, and therefore, are not ideal for one ear use. Prior art two ear only systems used with one ear typically tend to slide off the head, displace the remaining earphone, and/or otherwise interfere with and cause inadequate use of the remaining earphone. These inefficiencies are avoided with the present invention.

### SUMMARY OF THE INVENTION

The invention involves a headphone system that can switch between monaural and binaural audio and/or listening capabilities. The invention is a headphone system and method comprising two interconnected earphones (by wires or wirelessly or otherwise) and means for switching between using the headphone with one earphone or two. The invention additionally contemplates, but must not necessarily contain (although it is contemplated to include) additional switching means for turning off and on the audio in one or both earphones, either as the system is switched between monaural and binaural use or as is. The audio on/off feature is also contemplated for use and can be used without switching the physical headphone/earphone position but rather merely switching between monaural and binaural use by utilizing the audio switching means to turn on and/or off the audio in one or more earphones. Instead of turning off the audio, the on/off feature could turn the audio down and up; a variable audio level switch is contemplated, not only a true on/off type switch. For example, there are at least four active modes that the present invention is contemplated to engage in. First, where both earphones have the audio on while the system is switched between one and two ear use. Second, where the audio in the primarily engaged earphone turns off (or lower) when the system is switched from two ear to one ear use (and goes back on (or higher) when engaged from one ear to two ear use). Third, where the audio remains on in both ears while the system is used for two ear use. And fourth, where the audio in one or both ears is turned off (or lower) while the system is in two ear use.

### DETAILED DESCRIPTION OF THE INVENTION

The current invention contemplates both a removable and non-removable device. A non-removable system comprises two earphones irremovably secured to a band or other connecting device (hereafter ‘band’), or other part of the system with means for adjusting from a two ear system to a one ear system. A removable system comprises two earphones, wherein one or both of the earphones are removably secured to a band or other part of the system. For example, a system comprising one earphone with a microphone for speaking, one earphone without a microphone, and a band secured removably to at least one earphone, would enable the user to convert the device from a two ear system into a one ear system with either an earphone that has a microphone or an earphone that does not have a microphone. The microphone may be removable as well, resulting in a one ear or two ear system without a microphone. The current invention also contemplates that any suitable contemplated earphone feature could be adapted to a left or right earphone, or both. A system without a band is also contemplated. The system would be otherwise connected in any case (e.g., by wires or wirelessly). Contemplated connections between the earphones of the present invention comprise physical (e.g., a band) as well as electronic (e.g., wire or wireless) connections.

The current invention uses switching means for adjustment of the system from a two ear system to a one ear system and vice versa. The current invention contemplates any such means that would accomplish the switching task adequately, including but not limited to, hinge means, telescopic means, slide means, velcro means, pliable means, bending means, removable/removing means, spring means, and/or twisting means. Preferred electronic switching means would allow for turning the audio off in one earphone or the other while having the audio on in the other. Prior art electronic means for turning the audio off, or muting, both headphone earphones in an audio signal output device wherein switching means are not located, as contemplated in this invention, in the headphone system itself, can be seen in Wakui, U.S. Pat. No. 5,526,434. Other preferred switching means would allow for adjustment of at least one earphone up or around the head, face, and/or ear such that the earphone would rest generally in a position against the head, although positions away from or near the head are contemplated. Also preferred would be means to position at least one earphone wherein the adjusted earphone would rest is a position generally against the head in contact with a band or other part of the system, if any.

Means for switching the audio off in only one earphone are also contemplated by this invention. Also, means for switching the audio off in one earphone, for example, while also moving the one earphone (e.g., the adjusted earphone) are contemplated by this invention. this might be done automatically, partially automatically, partially manually, and/or manually. The switching means, for example, could include a handle or some other part that when engaged (e.g., twisted, pressed, adjusted, squeezed, or otherwise engaged), switches and moves the system from a two ear system to a one ear system, by a hinge or spring or some other means, and also automatically (or otherwise) switches off the audio in one earphone (e.g., the adjusted earphone) to render the system monaural. This system could also automatically switch the audio in that earphone back on to make the system binaural. The preferred electronic means are contemplated to be usable with any switching means although they need not be. For example, one such combinatory use contemplates switching one earphone to a different position and simultaneously switching off the audio of the adjusted earphone. The audio need not be turned off, however. This is only one embodiment of the present invention and any novel combination of the above features is contemplated as part of the patented system and method.

Earphones that are contemplated for use in this invention comprise in-the-ear types, over-the-ear types, and/or earphones that cover the ear, both entirely and partially, as well as combinations. Earphone types that come into usage in the future that can be adapted to this invention are also contemplated. Bands that are contemplated for use in this device include over-the-head types, behind-the-ear types, and any other types that would accomplish the multi-function aspects of the invention. A band is not required, however.

The switching means contemplated by this invention may comprise automatic, partially automatic, partially manual, or manual means, comprising pad(s), headrest(s), other securing, fitting, and/or fastening device(s), button(s), switch(es), handle(s), or other mean(s), including electronic means.

1. A headphone system comprising two headphone earphones that output audio, a connection between the two earphones, at least one switching means within the headphone system capable of switching the system back and forth from a monaural system to a binaural system, and from a binaural system to a monaural system.

2. A headphone system according to claim 1 wherein said switching means switches off the audio in at least one headphone earphone when the system is engaged to be in monaural telephonic mode and switches the audio on in at least one headphone earphone when the system is engaged to be binaural.

3. (canceled)

4. (canceled)

5. (canceled)

6. A headphone system comprising two headphone earphones that output audio, a connection between the two earphones, at least one switching means within the headphone system capable of switching the system back and forth from a monaural telephonic system to a binaural system, and from a binaural system to a monaural telephonic system.
